(19) United States
(12) Patent Application Publication
(10) Pub. No.: US 2023/0230501 A1
(43) Pub. Date: Jul. 20, 2023

(54) SYSTEM AND METHOD FOR INTERACTIVE AND HANDSFREE LANGUAGE LEARNING

(71) Applicants: Alexandru ILIESCU, Brasov (RO); Tudor ILIESCU, Brasov (RO)

(72) Inventors: Alexandru ILIESCU, Brasov (RO); Tudor ILIESCU, Brasov (RO)

(21) Appl. No.: 18/010,171

(22) PCT Filed: Jul. 1, 2021
(86) PCT No.: PCT/EP2021/068177

§ 371 Date: Dec. 13, 2022

Related U.S. Application Data
(60) Provisional application No. 63/046,748, filed on Jul. 1, 2020.

(51) Int. Cl. G09B 19/06; G09B 5/04

(52) U.S. Cl. CPC G09B 19/06; G09B 5/04

(57) ABSTRACT

A system and method for assisting a user in learning a target non-native language includes a processor executing instructions stored on a computer-readable medium, the executed instructions causing the processor to provide the user with an audible presentation of a word or a phrase in the target non-native language and prompting the user to audibly respond with speech data. The system captures the audible response and converts the audible response into input text data, then evaluates the text data for accuracy by comparing text characters in the text data to anticipated text data contained in a database. The system calculates the number of incorrect characters in the text data, then converts the evaluated text data into an output audio file and reads back the audio file to the user. The readback provided by the system provides audible feedback to the user regarding the accuracy of the evaluated text data.

This PCT application claims priority to U.S. Provisional Patent App. No. 63/046,748, filed on Jul. 1, 2020, herein incorporated by reference.

### FIELD

The present invention relates to an interactive system and method for learning a select new language.

### BACKGROUND

Our world is a multi-lingual world. With continued globalization and cross-border collaboration, the ability to speak more than one language is becoming increasingly more important in order to succeed both at international and national levels. Communicating clearly and effectively in someone's native language not only reduces communication errors, but also improves efficiency and productivity.

Language learning computer applications (“apps”) have become ubiquitous as learners increasingly look to technological platforms to facilitate language learning versus in-person tutoring for both convenience and cost. While these apps can be effective for basic language learning, they rely on visual prompts and user interaction with display screens. Such apps do not provide for interactivity and, most importantly, real-time actionable correction and feedback in the same way that in-person tutoring can provide. Therefore, there is a need for a system and method for learning a new language that does not rely on visual prompts or display screen interaction, and provides interactivity and real time actionable correction and feedback.

### SUMMARY

A system and method for assisting a user in learning a targeted non-native language is disclosed according to an embodiment of the present invention. In one embodiment of the present invention a system comprising one or more processors execute instructions stored on a computer-readable medium. The executed instructions cause the system to provide the user with an audible presentation of a word or a phrase in the targeted non-native language, prompting the user to audibly respond as speech data. The system captures the speech data and converts the speech data into text data using a speech recognition system that analyzes the speech data. The system then evaluates the text data by comparing text characters in the text data to anticipated text data contained in a database and calculating number of incorrect characters to determine the accuracy of the evaluated text data. The evaluated text data is converted back into an audio file with a text-to-speech conversion subsystem. The system then reads back the audio file to the user, thereby providing audible feedback to the user relating to the accuracy of the evaluated text data.

In an embodiment of the present invention a system for interactive language learning includes an audio input device, an audio to text converter coupled to the audio input device, a processor coupled to the audio to text converter, a predetermined set of instructions on a storage medium and readable by the processor, a speech generator coupled to the processor, and an audio output device coupled to the speech generator. A word or phrase spoken in a select language is detected by the audio input device and converted to a corresponding input electrical signal by the audio input device, then further converted to corresponding input text by the audio to text converter. The processor analyzes and evaluates the input text in comparison to predetermined reference text representing the correct pronunciation of the word or phrase in the select language, the processor outputting to the text to speech converter a text analysis evaluation of the comparison. The text to speech converter provides to the audio output device an output electrical signal corresponding to the text analysis, and the audio output device produces an audio signal corresponding to the text analysis.

The currently disclosed invention provides for an innovative and efficient system and method for learning a new language. The readback element of the currently-claimed system and method provides several advantages over the prior art. For example, it allows the user to receive immediate feedback, which in turn allows the user to correct their understanding and pronunciation accordingly. The readback element also provides a learning experience similar to that provided by in-person classroom lessons with the convenience of accessibility from any place at any time. Moreover, the audible or spoken interaction between the system and the user provides for hands-free interactivity, simplifying the learning process. It also reduces the need for physical interaction between the user and the system's input controls, which allows the user to multitask while learning a new language.

### BRIEF DESCRIPTION OF THE DRAWINGS

Further features of the present invention will become apparent to those skilled in the art to which the present invention relates from reading the following specification with reference to the accompanying drawings, in which:

FIG. 1 is a schematic block diagram of a system for learning a new language according to an embodiment of the present invention;

FIG. 2 is a high-level schematic block diagram describing operation of the system of FIG. 1;

FIGS. 3A and 3B are a schematic block diagram showing the operation of the system of FIG. 1 to carry out a lesson according to an embodiment of the present invention; and

FIGS. 4A and 4B show a language complexity level diagram utilized by the system of FIG. 1.

### DETAILED DESCRIPTION

A system and method for assisting a user in learning a targeted non-native language is disclosed according to an embodiment of the present invention. In one embodiment the system and method comprises one or more processors executing instructions stored on a computer-readable medium. The computer-readable medium may include permanent memory storage devices, such as computer hard drives or servers. Examples of machines and devices that utilize processors, memory, and instructions stored on computer-readable mediums include, but are not limited to, servers, computers, mobile devices, such as cellular telephones, and terminals.

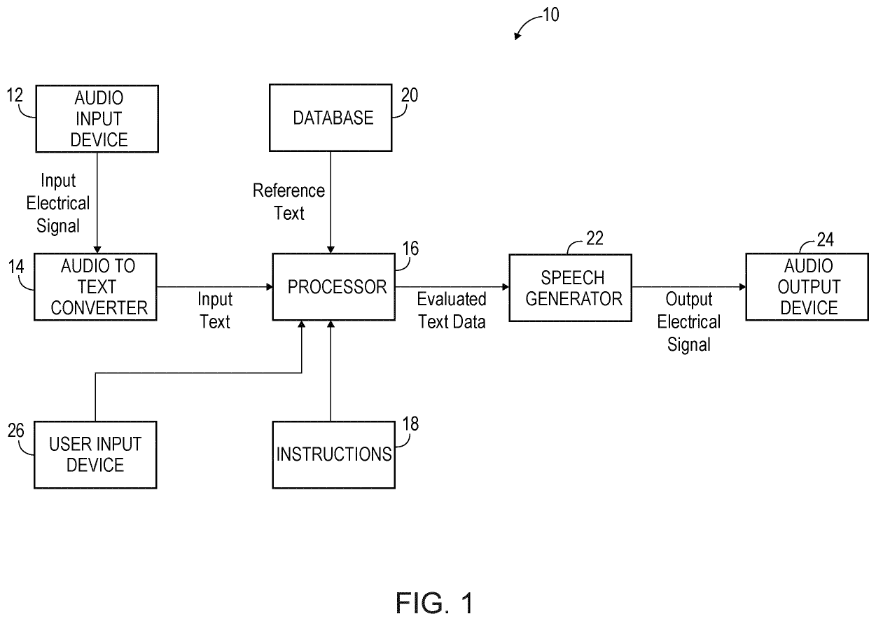

Details of a non-limiting system 10 to facilitate learning a new language are shown in FIG. 1 according to an embodiment of the present invention. An audio input device 12 receives audio input and provides an electrical input signal representing the audio input to an audio-to-text converter 14. Converter 14 converts the input electrical signal to a corresponding input text. The input text is provided to a processor 16, which utilizes a predetermined set of instructions 18 and a database 20 to analyze the audio input. For example, processor 16 may compare the input text to predetermined reference text stored in database 20. The results of the analysis are provided to a speech generator 22, which generates a corresponding audio output electrical signal that is emitted in an aural form using an audio output device 24.

Audio input device 12 may be any suitable transducer configured to convert audio signals to a corresponding input electrical signal, such as one or more microphones. Audio input device 12 may optionally include audio enhancing features in hardware and/or software form such as audio processors, noise limiters, compressors, equalizers, amplifiers, and filters. The input electrical signal may be in any analog or digital form readable by audio to text converter 14, and may be stored as an audio file in a suitable storage medium.

Audio to text converter 14 converts the electrical signal from audio input device 12 to corresponding input text in a form and format that can be recognized by processor 16. Converter 14 may be implemented in dedicated hardware, software operated on a generic platform, or a combination of hardware and software.

Processor 16 may be any suitable type of computing device including, without limitation, one or more central or distributed microprocessors, microcontrollers, or computers. Processor 16 may be implemented in dedicated hardware, software operated on a generic platform, or a combination of hardware and software.

Instructions 18 and database 20 may be in any form compatible with processor 16 including, without limitation, a computer-readable storage medium with a standard computing language or a proprietary or custom computing language stored thereon, as well as predetermined logic arrays and other hardware-only implementations of the instructions. As previously noted, the computer-readable medium upon which instructions 18 and database 20 are stored may include, without limitation permanent memory storage devices, such as computer hard drives or servers. Portable memory storage devices such as USB drives and external hard drives may also be utilized.

In some embodiments database 20 is configured to collect user performance information such as correct answers, incorrect answers, and number of trials. This information helps construct the lesson flow. User performance information may be saved for future analysis, or used temporarily by system 10 during a lesson.

Speech generator 22 receives predetermined signals from processor resulting from the analysis performed by the processor and converts the signals to an output electrical signal representing speech. Speech generator 22 may be implemented in dedicated hardware, software operated on a generic platform, or a combination of hardware and software. The output electrical signal may be in any analog or digital form readable by audio output device 24, and may be stored as an audio file in a suitable storage medium.

Audio output device 24 receives the audio speech output electrical signal and acts as a transducer to convert the electrical speech output signal to an audio signal that can be perceived by a user of system 10. Audio output device 24 may be a transducer such as one or more speakers. Audio output device 24 may also include audio processing features such as amplifiers and filters.

The foregoing components of system 10 may be realized using discrete subsystems that are mechanically and electrically coupled together to form the system. Alternatively, some or all of the components of system 10 may be integrated together and placed on a common substrate such as a chassis or printed circuit assembly. Example system 10 configurations may include, without limitation, one or more of: servers; computers; mobile devices such as cellular telephones; vehicle audio and entertainment systems; “smart” speakers; “smart” televisions and other “smart” appliances; augmented reality (AR), virtual reality (VR) and cross reality (XR) devices such as goggles, headsets, glasses and other wearable intelligence; and terminals. In some embodiments of the present invention some portions of system 10 may be located remotely from the others. For example, processor 16, instructions 18 and database 20 may be located remotely and coupled to the other components of system 10 and in communication with the other components using any suitable devices, such as a wired or wireless transmitter-receiver arrangement.

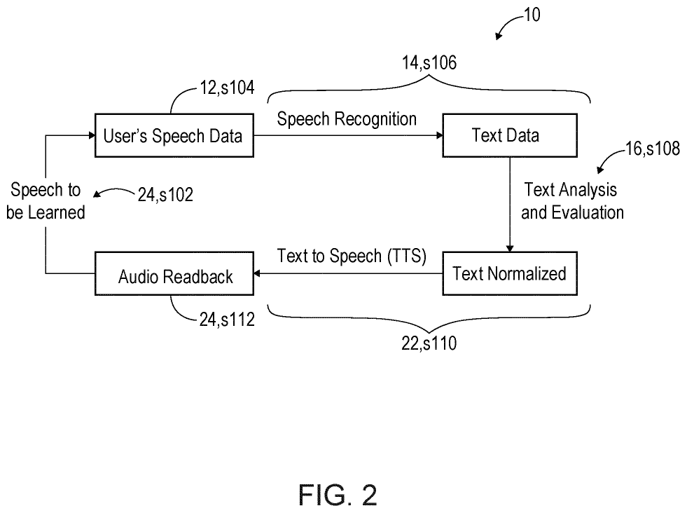

With reference now to FIGS. 1 and 2 together, in operation of system 10 at s102 output device 24 aurally issues a test word or phrase to be learned and prompts the user, in response to which a user provides at s104 speech data to audio input device 12 comprising the user's attempt to pronounce the word or phrase. At s106 the speech data of s104 is converted to input text by converter 14, then analyzed at s108 by processor 16. At s110 the results of an analysis evaluation are converted to an audible speech signal by speech generator 22. The audible speech signal is emitted by audio output device 24, providing the user with audio readback at s112 relating to the word or phrase spoken by the user at s104. The readback of s112 provides the user with immediate aural, hands-free feedback with respect to the user's ability to pronounce the word or phrase. This, in turn, aids the user to learn how to self-correct and properly pronounce the word or phrase in real time, in a manner similar to that of a student receiving instruction from a live tutor without the need for in-person classes.

Instructions 18, which can be stored on any suitable computer-readable medium, involve lessons for learning a non-native language. Each lesson may involve individual words. Alternatively, or additionally, each lesson may involve phrases. Furthermore, each lesson may involve tests or quizzes.

With reference now to FIGS. 1, 2, 3A, 3B, 4A and 4B together, in an embodiment of the present invention a user selects their native language and the target non-native target language they are interested in learning. A lesson begins by system 10 providing the user with a word or a phrase at s102 and prompting for a response from the user. The word or phrase may be presented once in the native language and twice in the target non-native language. System 10 may emphasize certain syllables in words to show correct pronunciation and/or spelling of the word. Alternatively, or in addition, system 10 may emphasize certain words in a phrase to further indicate the user said word is required.

The user then repeats the word or phrase into audio input device 12 at s104, the audio input device capturing the user's speech data in an electrical input signal such as an audio file. Speech recognition system 14 converts the speech data into input text data at s106. The input text data is analyzed by processor 16 by turning the input text data into characters and comparing said characters to answers in database 20. Then, the accuracy of the input text data is determined by processor 16 at s108, resulting in evaluated text data.

Text to speech system 22 converts the evaluated text data into speech data at s110. The evaluated speech data is read back to the user by audio output device 24 at s112 in a computer-generated audio file. In addition, feedback may be provided as to whether the user's response was correct, incorrect or partially correct.

The user may interact with system 10 using either voice commands via audio input device 12 and/or any suitable user input device 26 (FIG. 1). User input device 26 may include, without limitation, one or more switches, keyboards, and programmed touch screens with programmed key inputs and one or more menus. In addition to the lessons described herein, such interactions may include, without limitation, preferences, setup configuration, user information, subscription information, adjustments, native and known languages, and target languages.

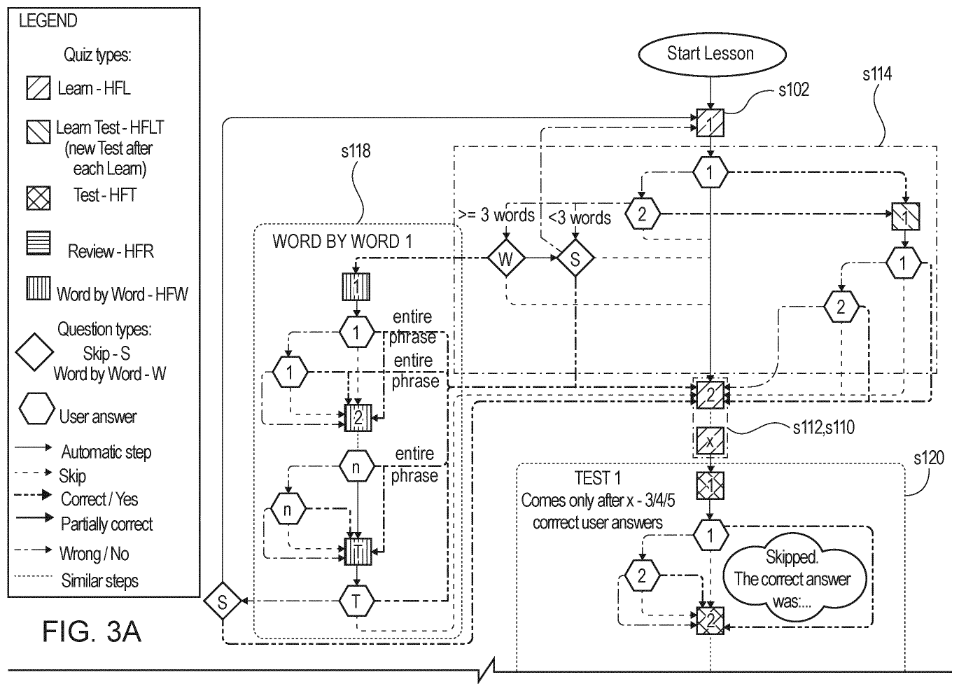

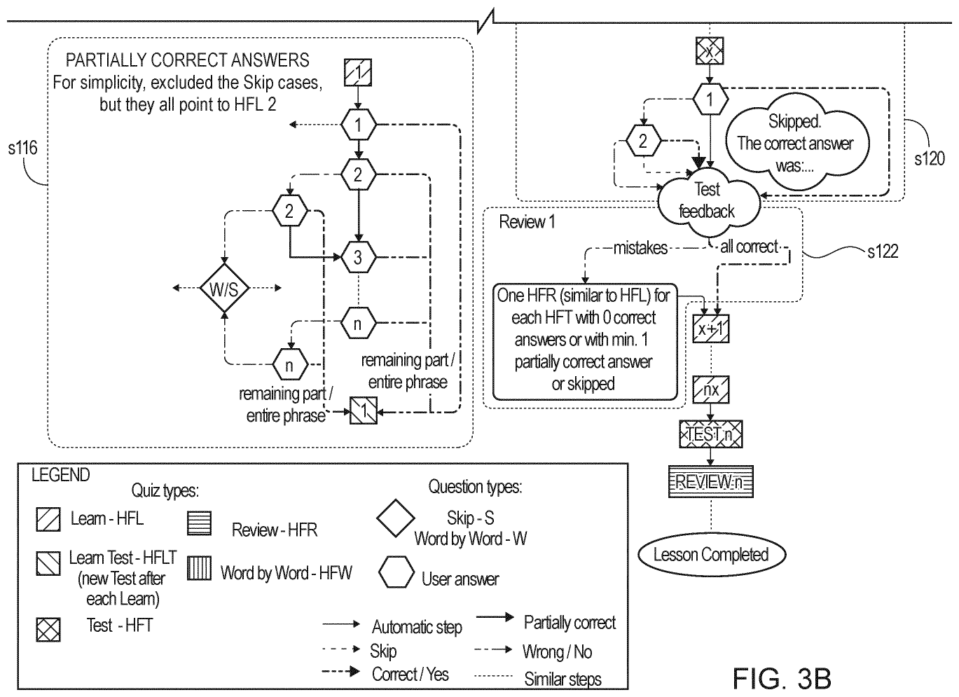

With reference to FIGS. 3A and 3B in combination with FIGS. 1, 2, 4A and 4B, an example lesson structure implementing system 10 is shown as one non-limiting embodiment of the present invention. A lesson comprises three primary modules or areas. First is a “learn” portion, wherein new information is presented to the user. This is followed by a “quiz” or “test” portion wherein the user's learning of the new information is evaluated. The quiz portion of the lesson is followed by a review portion wherein incorrect answers from quiz are repeated to ensure that the user memorizes the content. In one embodiment of the review portion, if the user gives two incorrect answers to the same quiz question, the question will be asked again in review.

The lesson begins at s102 by system 10 providing the user with a word or a phrase. The grade of difficulty of the word or phrase provided to the user in the target non-native language may depend on the level of expertise of the user. The expertise of the user may be classified as beginner, intermediate, or advanced. The user's expertise may be determined by processor 16 analyzing the accuracy of the user's responses or evaluated text data as the language lesson progresses. As the lesson advances, the grade of difficulty of the word or phrase provided may increase as the accuracy of the evaluated text data increases. Similarly, the grade of difficulty of the word or phrase provided may decrease as the accuracy of the evaluated dated decreases.

Alternatively, or in addition, the user may select their own expertise level; thus, selecting the grade of difficulty of the word or phrase provided. As the lesson progresses, the user may change their expertise level. Alternatively, or in addition, as the lesson progresses, the system 10 may prompt the user to adjust their expertise level to a higher or lower classification. Said prompt may be based on the accuracy of the evaluated text data.

Further, the grade of difficulty of the provided word or phrase may further depend on a complexity level determined by comparing the user's native language and the target language. The complexity level between the user's native language and the target language is determined based on several factors, including but not limited to, the similarity between the languages by comparing each language's root, syntax, and alphabet. Moreover, the complexity level classification between specific native/target languages combinations may be updated as data is collected from users' evaluated text data.

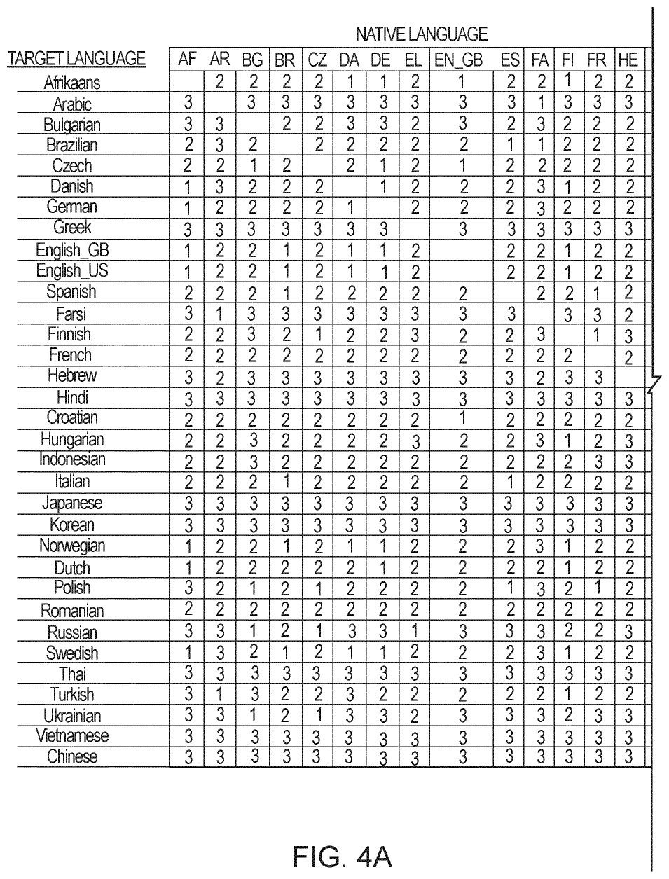

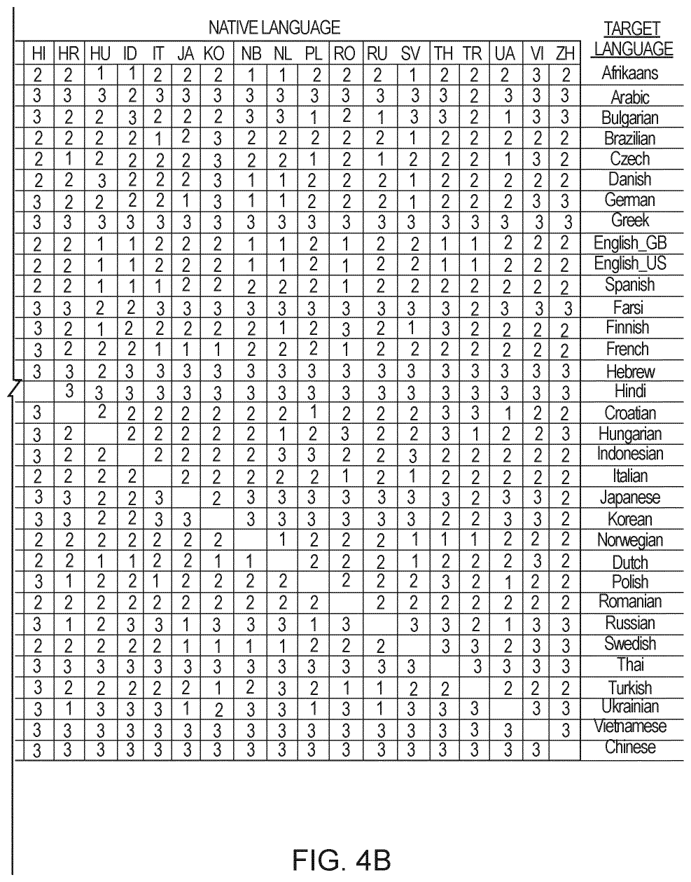

As illustrated in FIGS. 4A and 4B, the complexity level may be classified as type 1, type 2, and type 3, wherein the grade of difficulty increases from type 1 to type 3. For example, a user whose native language is English from the USA and the target language is Chinese will result in a complexity level of 3 as these languages do not share the same root or alphabet and their syntax is different. Analysis of user performance data gathered and stored by system 10 may also be utilized to determine complexity level, using such factors as completion rate, fail rate, and quit rate per each language combination. Thus, for example, a lesson involving a beginner user and a type 3-complexity level may result in a lower grade of difficulty and be limited to individual words with nine or less characters or phrases with five or less words.

As explained above, once the word or phrase is provided to the user, system 10 will ask the user to answer or repeat the word or phrase, generating speech data at s104. The speech recognition system 14 converts the speech data into text data at s106. The text data is converted to text characters and its accuracy is evaluated by processor 16.

The accuracy of the evaluated text data is determined by processor 16 of system 10 comparing the generated text characters with anticipated text data or answers stored in database 20. A user's answer may be classified as correct (FIG. 3A, s114), partially correct (FIG. 3B, s116), or incorrect (FIG. 3A, s118) wherein s114, s116 and s118 each include steps s106, s108 as sub-steps.

In one embodiment a user's answer or evaluated text data is considered to be correct (FIG. 3A, s114) if the number of incorrect characters in the evaluated text data as compared with the anticipated text data does not exceed the number of text characters in the evaluated text data divided by a tolerance value. The tolerance value may vary depending on further optimizations and/or findings. The tolerance value may depend on the complexity level between the user's native language and the target language, user's expertise level, etc. For example, a user's answer or evaluated text data may be considered to be correct (FIG. 3A, s114) if the number of incorrect characters in the evaluated text data as compared with the anticipated text data does not exceed the number of text characters in the evaluated text data divided by 10. If applicable, the total number of text characters also includes blanks between words or phrases. The accuracy of the evaluated data may also include a comparison between the user's pronunciation and the correct pronunciation.

The complexity level between the native language and the target language may also be considered when determining the accuracy of a user's answer or evaluated text data. As the complexity level increases, the number of accepted incorrect characters may increase. For example, the number of acceptable incorrect characters involving a type 3-complexity level maybe double the number of acceptable incorrect characters involving a type 1-complexity level.

A user's answer or evaluated text data may be classified as partially correct (FIG. 3B, s116) if the number of incorrect characters in the evaluated text data as compared with the anticipated text data does not exceed an acceptable number of text characters in the evaluated text data. Alternatively, or in addition, an answer may be considered partially correct if the user's answer includes only parts of the anticipated text data. In said case, the system may provide the user with an audible prompt with the missing parts of the anticipated text data or correct answer.

Other factors may be considered when determining if a user's answer is partially correct. For example, the user's level of expertise, the target non-native language classification, grade of difficulty of the provided word or phrase, and the user's native language may be considered when determining the acceptable number of incorrect characters.

Once the text data is evaluated for accuracy, the evaluated text data is converted to evaluated speech data or audio file at s110 by text to speech system 22. The evaluated speech data is then read back to the user via audio output device 24 at s112. The electrical output signal audio file is based on what the system 10 “understood” from the user's speech data, e.g., the fidelity of the user's pronunciation of the word or phrase in comparison to the correct pronunciation of the word or phrase stored in database 20 and emitted at s102 by audio output device 24. The readback comprises a representation of how the spoken word or phrase provided by the user would be perceived by a speaker of the select target language. For example, an accent introduced by the user may affect the user's pronunciation of a word or phrase in the target language. Thus, the audio readback function of s112 provides the user with further understanding and feedback on how their answer is being perceived and evaluated by a speaker of the target language, and the user may change and correct their answer accordingly, if needed. This unique readback function provides the user with immediate feedback on how their answer was understood, which in turn allows the user to self-correct in real time as if they were interacting with a live tutor.

In some embodiments of system 10 when the user has to answer a question and does not speak for several seconds, system 10 may assist the user by speaking out loud via audio output device 24 the first several words of the answer. When the user speaks only the first part of a phrase, system 10 may acknowledge that the answer is partially correct, and then help by speaking the last part of the answer. System 10 is also able to stress out the pronunciation of some words, so the user can understand how to accentuate the word, or that a certain word needs to be used.

As shown in FIG. 3A, if the user's answer or text data is considered to be correct (s114), then the lesson will continue with another word or phrase. If the user does not respond to the system's prompt within a predetermined amount of time, then system 10 will proceed to repeat the prompt. Alternatively, or additionally, after not receiving the user's reply within a predetermined amount of time, system 10 may provide the user with an audible prompt, for example, the first or two syllables of the answer if the answer is a word; or the first or two words of the answer if the answer is a phrase.

After certain number of correct user's answers, for example three to five correct user's answers, the lesson will continue with a test (FIG. 3B, s120). A test may include a structured or rule-based sequence of activities requiring the user's participation. The test may be in the form of questions or prompts, to which the user is prompted to provide verbal responses.

In one embodiment, a test may involve giving the user questions relating to the previously provided words or phrases, but in a different order or sequence. The user's test answers are evaluated in similar manner to the words or phrases at the beginning of the lesson. For example, at the end of each test, if all user's test answers are correct, then a new lesson may be started. Alternatively, or in addition, if at the end of the test, a certain number of answers are considered incorrect, for example, three or more answers are considered to be incorrect, then a new test may be automatically generated. Alternatively, or in addition, if at the end of the test, a certain number of answers are considered incorrect, for example, two or less answers are considered to be incorrect, then a review lesson may be generated.

In one embodiment, a test may involve giving the user questions relating to the previously provided words or phrases, but in a different order or sequence. The user's test answers are evaluated by system 10 in similar manner to the words or phrases at the beginning of the lesson. For example, at the end of each test, if all user's test answers are correct, then a new lesson may be started. Alternatively, or in addition, if at the end of the test, a certain number of answers are considered incorrect, for example, three or more answers are considered to be incorrect, then a new test may be automatically generated. Alternatively, or in addition, if at the end of the test, a certain number of answers are considered incorrect, for example, two or less answers are considered to be incorrect, then a review lesson may be generated.

A review lesson (FIG. 3B, s122) may involve repeating the lesson but limited to the words or phrases considered to be incorrect and/or partially correct. Similar to the lesson, in a review lesson, system 10 will provide a word or a phrase to the user at s102 prompting the user to repeat the same, generating a corresponding input electrical signal such as an audio file at s104 with the user's speech data at s106. The speech recognition system 14 converts the speech data into text data. The text data is evaluated by processor 16 at s108 for accuracy by converting the text data into characters and comparing said characters to answers in database 20, resulting in evaluated text data. The text to speech system 22 converts the evaluated text data into evaluated speech data at s110. The evaluated speech data is read back to the user at s112, the evaluated speech data being in aural form emitted by audio output device 24, providing immediate feedback to the user.

If the user's answer or evaluated text data is considered to be incorrect (FIG. 3A, s118), then the word or phrase in the target language will be presented a second time. Alternatively, or in addition, if the user's answer or text data is considered to be incorrect, then the user may elect to move to a different lesson. Alternatively, or in addition, if the phrase involves a certain number of words, for example, three or more words, the user may elect to convert the phrase into a word-by-word lesson. As described above, the user will be prompted to repeat the first word in the target language. If the user's answer is correct, then the user will be prompted to repeat the second word. If the user's answer is incorrect, then the same word is presented again in the target language. This same process is followed with all the words in the phrase. Once correct answers are obtained for all words, then the lesson will be repeated with the whole phrase.

If the user's answer or text data is considered to be partially correct (FIG. 3B, S116), then the word or phrase in the target language will be presented a second time. If the user's second answer or text data is considered to be correct, then the lesson will continue with another word or phrase. If the user's second answer or text data is considered to be partially correct again, then the word or phrase in the target language will be presented a third time. If the user's second answer or text data is considered to be incorrect, then the word or phrase in the target language will be presented again. Alternatively, or in addition, if the user's answer or text data is considered to be incorrect, then the user may elect to move to a different lesson.

“Correct answers” may also include alternate answers. Alternate answers comprise answers that do not match what was taught but are considered correct for the language being taught.

In some embodiments of the present invention system 10 may include gamification features to add to the user's enjoyment. For example, the user may earn and collect points and awards based on their performance. Users may also be linked together using any suitable communication devices to share information relating to earned points for the purpose of listing on a leaderboard available to one or more users.

In addition to the test words or phrases and readback discussed above, system 10 may provide a user with visual and/or aural information including, but not limited to, instructions, test results, suggestions for improvement, updates, system status, responses to user input and controls, error messages, gamification points and awards, and encouragement. In some embodiments of the present invention system 10 may initially present the information to the user in the user's native (or known) language, then gradually begin providing at least a portion of the information in the target language as the user becomes more proficient with the target language. In this way the user becomes more and more interactively immersed in the target language as the user's proficiency in the target language increases.

As described above, the currently disclosed invention provides a system and method for learning a new language. In some embodiments of the present invention the system 10 may be implemented in a mobile-enabled application, such as for a cellular telephone or tablet computer, wherein the interaction between the system and the learner is hands-free, increasing convenience and ease while imitating real-life learning interactions such as tutoring by providing immediate feedback by a readback function.

From the above description of the invention, those skilled in the art will perceive improvements, changes, and modifications in the invention. Such improvements, changes, and modifications within the skill of the art are intended to be covered.

What is claimed is:

1. A system for interactive language learning, comprising:
an audio input device;
an audio to text converter coupled to the audio input device;
a processor coupled to the audio to text converter;
a predetermined set of instructions readable by the processor;
a speech generator coupled to the processor; and
an audio output device coupled to the speech generator,
wherein a word or phrase spoken in a select language is detected by the audio input device and converted to a corresponding input electrical signal by the audio input device, then further converted to corresponding input text by the audio to text converter,
wherein the processor analyzes and evaluates the input text in comparison to predetermined reference text representing the correct pronunciation of the word or phrase in the select language, the processor outputting to the text to speech converter a text analysis of the comparison, and
wherein the text to speech converter provides to the audio output device an output electrical signal corresponding to the text analysis, the audio output device producing an audio signal corresponding to the text analysis.

2. The system of claim 1 wherein the text analysis is a readback of the spoken text or phrase, the readback providing a user with audible feedback regarding the fidelity of the spoken word or phrase to the select language, the system thereby acting as an interactive tutor.

3. The system of claim 2 wherein the readback includes information relating to the accuracy of the spoken word or phrase.

4. The system of claim 2 wherein the readback comprises a representation of how the spoken word or phrase would be perceived by a speaker of the select language.

5. The system of claim 1, further comprising a database coupled to the processor.

6. The system of claim 5 wherein the database is stored upon a computer readable storage medium.

7. The system of claim 1 wherein the audio input device is a microphone.

8. The system of claim 1 wherein the audio output device is a speaker.

9. The system of claim 1 wherein the instructions are stored upon a computer-readable storage medium.

10. The system of claim 1 wherein the instructions include a lesson for learning a non-native language.

11. The system of claim 10 wherein the lesson includes a plurality of complexity levels.

12. The system of claim 10 wherein the lesson includes at least one quiz.

13. A method for assisting a user in learning a target non-native language, said method comprising:
one or more processors executing instructions stored on a computer-readable medium, the executed instructions causing the one or more processors to perform steps comprising:
providing the user with an audible presentation of a word or a phrase in the target non-native language prompting the user to audibly respond as speech data;
capturing the speech data;
converting the speech data into input text data, wherein the input text data is generated by a speech recognition system analyzing the speech data;
evaluating the text data for accuracy by comparing text characters in the input text data to anticipated text data contained in a database and calculating number of incorrect characters;
converting the evaluated text data into an output audio file using a speech generator system;
reading back the audio file to the user; and
providing audible feedback to the user based on the accuracy of the evaluated text data.

14. The method for assisting a user in learning a target non-native language as claimed in claim 13, wherein the audible feedback provided to the user comprises a correct answer feedback, a partially correct answer, or an incorrect answer.

15. The method for assisting a user in learning a target non-native language as claimed in claim 14, wherein a correct answer feedback is generated when the number of incorrect characters in the evaluated text data as compared with the anticipated text data does not exceed the number of text characters in the evaluated text data divided by a tolerance value.

16. The method for assisting a user in learning a target non-native language as claimed in in claim 13, further comprising the step of determining a complexity level between the user's native language and the target non-native language.

17. The method for assisting a user in learning a target non-native language as claimed in in claim 16, wherein the complexity level between the user's native language and the target non-native language is determined by comparing the native language's root, syntax, or alphabet with the target language's root, syntax, or alphabet.

18. The method for assisting a user in learning a target non-native language as claimed in in claim 17, wherein the step of evaluating the text data for accuracy further includes the complexity level between the user's native language and the target non-native language.

19. The method for assisting a user in learning a target non-native language as claimed in in claim 13, further comprising the step of determining grade of difficulty of the word or phrase in the target non-native language.

20. The method for assisting a user in learning a target non-native language as claimed in in claim 19, wherein the grade of difficulty of the word or phrase in the target non-native language is determined based on the accuracy of the evaluated text data.

21. The method for assisting a user in learning a target non-native language as claimed in in claim 13, wherein:
information is initially presented to the user in a language known to the user; and
wherein at least a portion of the information is presented to the user in the target language as the user becomes more proficient with the target language.
